(19) United States
(12) Patent Application Publication
(10) Pub. No.: US 2015/0034787 A1
(43) Pub. Date: Feb. 5, 2015

(54) Propane Tank Porter

(71) Applicant: Purna C. Ramini, Bentonville, AR (US)

(72) Inventor: Purna C. Ramini, Bentonville, AR (US)

(21) Appl. No.: 14/450,261

(22) Filed: Aug. 3, 2014

Related U.S. Application Data
(60) Provisional application No. 61/861,968, filed on Aug. 2, 2013.

(51) Int. Cl. F17C 13/08; B60P 7/135; B60T 3/00

(52) U.S. Cl. CPC F17C 13/084; B60T 3/00; B60P 7/135; F17C 2270/0168
USPC 248/346.05; 248/346.01

(57) ABSTRACT

Propane Tank Porter simplifies and solves the transit problems associated with domestic propane tank(s). Normally people carry propane tanks in their Car/Truck/SUV trunks. During the transit, they roll due to the motion/breaking of the vehicle and damage the trunk. This causes driver distractions, due to its rolling and bumping actions in the back of the Car/Truck/SUV trunk(s). Additionally it can spoil the trunk mats with the dirt that is sticking to propane tank(s) that naturally occur during the production process. The unique design of this “Propane Tank Porter” solves these problems, with its belted stoppers that sit on the either side of the propane tank (on its side laying position). Left & right stoppers have curved sides that hug the propane tank and small magnets connect the propane tank all the time. Belts are held in position due to gravity and the weight of the propane tank. Slim dirt mat that is connected to the belts sit between the 2 stoppers (left & right), under the propane tank, forming the dirt barrier.

### BACKGROUND

Domestic propane tanks are ported on their side-on position as they do not have stability in the standing position due to their small base. This causes the rolling action in trunk of the car/SUV or truck bed that can cause damage and driver distraction.

### SUMMARY

“Propane tank porter” stops the rolling of the propane tank during the transit with its uniquely designed left & right stoppers. Curve sides of the stoppers closely hug the propane tank with its belts connecting them that run under the tank. Weight of the tank keeps the belts connecting the left & right stoppers in the correct position. Left & right stoppers extends the base of the center of gravity, providing the additional stability. Small magnets that are on the top inner side of the left & right stoppers keep them connected to the propane tank all the time, even during the reasonably bumpy rides. Small dirt mat, that runs under the tank (length) and in between the left & right stoppers, forms the dirt barrier. FIG. 3 illustrates the usage from the side view.

### GENERAL DESCRIPTION OF DRAWINGS

FIG. 1 is showing the left stopper. Following is the description of the labelled items in this diagram. In FIG. 1, label 1.1 is showing the magnet that connects to the propane tank that provides constant contact with the propane tank. Label 1.2 is showing the curved outer side that hugs the propane tank. Label 1.3 is showing the belt slots where the belts are run through, to connect left & right stoppers. Label 1.4 is showing the belt glider tracks where belts are run through, to keep belts correctly positioned under the propane tank for maximum close contact. Label 1.5 is showing the stopper base which extends the center-of-gravity base, to provide additional stability. Label 1.6 is showing the smooth tucking edges which go very close to the propane tank out edge, for the most roll proof transit of the propane tank.

FIG. 2 is showing the right stopper. Following is the description of the labelled items in this diagram. In FIG. 2, label 2.1 is showing the magnet that connects to the propane tank that provides constant contact with the propane tank. Label 2.2 is showing the curved outer side that hugs the propane tank. Label 2.3 is showing the belt slots where the belts are run through, to connect left & right stoppers. Label 2.4 is showing the belt glider tracks where belts are run through, to keep belts correctly positioned under the propane tank for maximum close contact. Label 2.5 is showing the stopper base which extends the center-of-gravity base, to provide additional stability. Label 2.6 is showing the smooth tucking edges which go very close to the propane tank out edge, for the most roll proof transit of the propane tank.

FIG. 3 is illustrating the usage of the “Propane Tank Porter”. It is showing the side view of right & left stoppers that are labeled 3.2 & 3.3 respectively, propane tank on its side that is labeled 3.1, belts connecting left & right stoppers that are labeled 3.4, magnets on the left & right stoppers that are labeled 3.5 and dirt mat under the propane tank (between left & right stoppers) that is labeled 3.6.

In FIG. 3, it is illustrated that weight the tank naturally keeps the entire system and its structural integrity intact. Belts that are running through right & left pieces (3.2 & 3.3) are pulled downwards to keep them on base for stability and also pulled towards the center of the propane tank, to keep them close to the outer surface of the propane tank that prevents even minute rolling action.

FIG. 3 illustrates the use of magnets (3.5) on the right & left pieces (3.2 & 3.3), that establish the contact with propane tank all the time, even in reasonably bumpy rides.

FIG. 3 illustrates the usage of the dirt mat (3.6) that forms as dirt barrier between the propane tank and the vehicles trunk's/bed's mat. This dirt mat (3.6) has enough length & width that prevent the under surface of the propane tank from coming in contact with mat in the vehicle's trunk/bed. Due to its unique design, dirt mat (3.6) can be easily detached for cleaning or washing as it connected through the rectangular holes to the belts.

### GENERAL DESCRIPTION OF EXEMPLARY EMBODIMENTS

The entire design is centered around ease of use and long life of the product. Its unique design features enable the maximum transit roll proof protection. It is designed with minimal amount of parts that can be easily assembled or dis-assembled. It is easy to clean and store. It can be easily uninstalled or installed to the propane tank in the standing position, due to its magnets and belts placement & position. Its hollowed left and right stoppers are designed for light weight but still providing maximum strength for structural stability.

### BRIEF DESCRIPTION OF THE DRAWINGS

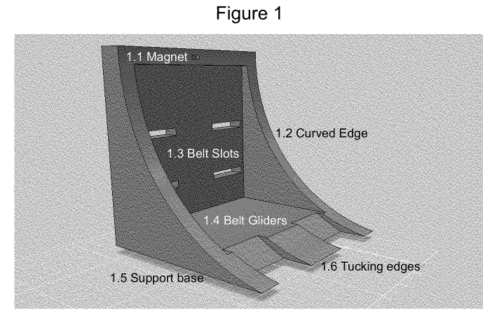

FIG. 1 is showing the left stopper(piece) of the ‘Propane Tank Porter’.

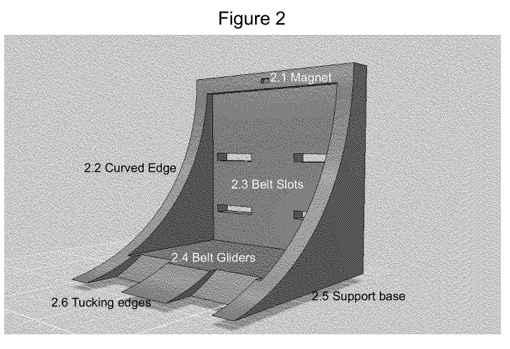

FIG. 2 is showing the right stopper(piece) of the ‘Propane Tank Porter’.

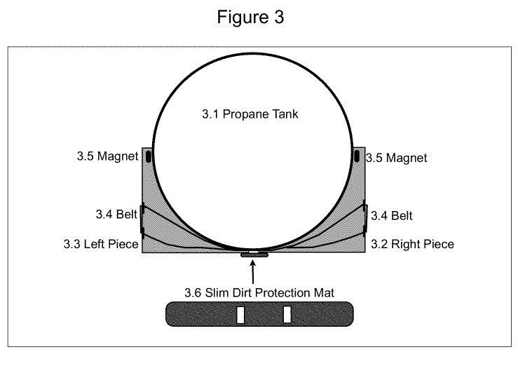

FIG. 3 is showing the side view of ‘Propane Tank Porter’, attached to the propane tank cylinder that is set on the ground on its side position.

1. A device that is used to transport a domestic propane tank in a moving vehicle on a flat surface that provides roll proof transit is unique.

2. A device that is used to transport a domestic propane tank in a moving vehicle that provides roll proof transit without tying to the vehicle with rope(s) or belt(s) is unique.

3. “Propane Tank Porter” design providing maximum roll proof transit of the propane tank in a moving vehicle's trunk/bed is unique.

4. “Propane Tank Porter” left & right stoppers hollow design that provides maximum structural stability is unique.

5. Use of magnets in the “Propane Tank Porter” to provide constant contact with the propane tank is unique.

6. Placement & position of belts connecting both left & right stoppers in the “Propane Tank Porter” that provides maximum structural stability is unique.

7. Left & right stoppers design in the “Propane Tank Porter” that extends the center-of-gravity base for maximum transit stability is unique.

8. Placement, position, size & shape of the dirt mat as a dirt barrier in the “Propane Tank Porter” is unique.

9. “Propane Tank Porter” left & right stoppers (both) identical (Same) design usage is unique.
